(19) United States
(12) Patent Application Publication
(10) Pub. No.: US 2022/0114921 A1
(43) Pub. Date: Apr. 14, 2022

(54) DIY BADGE TALKER

(71) Applicant: CCL INDUSTRIES INC. CORPORATION CANADA, Toronto (CA)

(72) Inventor: Kimberley Lynne SMITH, Delta (CA)

(21) Appl. No.: 17/268,112

(22) PCT Filed: Aug. 13, 2019
(86) PCT No.: PCT/CA2019/051109

§ 371 Date: Feb. 12, 2021

Related U.S. Application Data
(60) Provisional application No. 62/718,104, filed on Aug. 13, 2018.

(51) Int. Cl. G09F 3/10; B32B 7/12; B32B 3/26; B32B 5/02; B32B 5/26; B32B 7/06; B32B 27/08; B32B 27/12; B32B 27/10; B32B 27/36; B32B 29/00; B32B 29/02; C09J 7/40

(52) U.S. Cl. CPC G09F 3/10; B32B 7/12; B32B 3/266; B32B 5/022; B32B 5/266; B32B 7/06; G09F 2003/0201; B32B 27/12; B32B 27/10; B32B 27/36; B32B 29/005; B32B 29/02; C09J 7/403; B32B 27/08

(57) ABSTRACT

Provided is an at-home, do-it-yourself (DIY) printable label sheet comprising removable labels with a printable area and attachment portion on the same side of the individual labels. The attachment portion includes an adhesive for attachment of the label to the backside of an item, such as a badge, and a film that protects the adhesive prior to use. The film allows for an adhesive to be positioned on the front side of a printed label while preventing any potential damage to the printer due to exposed adhesive. The individual labels may also include a perforated tab. The label sheet may be inserted into a printer with a particular image printed thereon. The printed individual labels may be removed from the label sheet by using the perforated tab. The back of the individual label is free of adhesive. The perforated tab may be removed from the individual label along the perforation and the film may be removed from the adhesive on the individual label to apply the label to an item.

### CROSS-REFERENCE TO RELATED APPLICATION

This application claims priority to and the benefit of U.S. Provisional Application No. 62/718,104 entitled “DIY BADGE TALKER,” filed on Aug. 13, 2018, which is incorporated herein by reference in its entirety.

### FIELD OF THE DISCLOSURE

The present disclosure relates generally to labels and, more particularly, to an at-home, do-it-yourself (DIY) printable labels and label sheets for attachment to a badge, namely a DIY “badge talker,” and methods of use thereof.

### BACKGROUND

Labels are applied to products, shelves, and various other items to convey relevant information or aesthetic design. The information typically provided on a label is in the form of text, graphics, and images. Badges are often utilized at meetings, events, group activities, and in business or retail settings.

### SUMMARY

The following presents a summary of this disclosure to provide a basic understanding of some aspects. This summary is not intended to identify key or critical elements or define any limitations of embodiments or claims. Furthermore, this summary may provide a simplified overview of some aspects that may be described in greater detail in other portions of this disclosure.

Disclosed is a label sheet assembly comprising a liner layer, a facestock layer attached to the liner layer, a film layer attached to the facestock layer opposite from the liner layer, and at least one adhesive area positioned between the facestock layer and the film layer. A plurality of labels defined within the facestock layer wherein each label includes a front side and an opposite back side, the back side abuts the liner layer and the font side of each label includes a printable area and an attachment portion wherein the adhesive area is aligned along the attachment portion. The liner layer, the facestock layer, and the film layer may be square, or rectangular in shape and may be made from a material such as a polymer film, polyester label stock, paper, or a nonwoven material. The plurality of labels may be formed in the facestock layer by a die cut through at least one of the film layer, adhesive lane, and facestock layer. The film layer may include a removable film strip shaped to correspond to the attachment portion of each label for protecting the adhesive area prior to its removal. Each of the plurality of labels may include a uniform shape or each of the plurality of labels may include individual labels of various shapes. The adhesive area may include a plurality of adhesive lanes wherein each adhesive lane extends along a length of the label sheet assembly and are positioned between the facestock layer and the film layer and align along the attachment portions of the plurality of labels. The adhesive portions along the adhesive lanes may be positioned on the attachment portion of the individual labels, wherein the adhesive portions may be separate and/or non-uniform segments along a length of the label sheet assembly. The back side of the plurality of labels is adhesive free. The adhesive areas along the plurality of labels may allow each label to be attached to an item such that the printed area of each of the plurality of labels are visible from above, under, or to the side of the item to which it is attached.

The film layer may include a shape that generally corresponds to the shape of entirety of the facestock layer and includes a cut line that defines a film strip that is shaped to generally correspond to the adhesive portion along the attachment portion of each of the plurality of labels. The plurality of film strips may not cover the printable area of each of the plurality of labels. The at least one of the plurality of labels may include a perforated tab to assist in the removal of the label from the label sheet.

In another embodiment, provided is a label sheet assembly configured to be processed through a printer device comprising a liner layer, a facestock layer attached to the liner layer, a film layer attached to the facestock layer opposite from the liner layer, and at least one adhesive area positioned between the facestock layer and the film layer. A plurality of labels may be defined within the facestock layer wherein each label includes a front side and an opposite back side, the back side abuts the liner layer and the font side of each label includes a printable area and an attachment portion wherein the adhesive area is aligned with the attachment portion. The film layer includes a film strip shaped to correspond to the attachment portion of each label for protecting the adhesive portion prior to use. The adhesive areas along the plurality of labels allow each label to be attached to an item such that the printable areas of each of the plurality of labels are visible from above, under, or to the side of the item to which it is attached.

In another embodiment, provided is a method of making a label for a badge from a sheet assembly. The steps include providing a label sheet assembly having a liner layer, facestock layer, and film layer wherein a plurality of cut lines define a plurality of labels within the facestock layer. The label sheet assembly is inserted into a printer. Indicia is printed along a printable area on a first side of at least one of the plurality of labels, said printable area is positioned adjacent to an adhesive area on said first side of at least one of a plurality of labels defined within the label sheet assembly. The at least one label having indicia thereon is removed from the label sheet assembly. No adhesive may remain on the portion of the liner layer from which the individual label was removed. The label sheet assembly may be inserted back into a printer to print indicia along the printable area of at least one of the remaining plurality of labels. A film strip may be removed from one of the plurality of labels to expose the adhesive portion and said label may be applied to the backside of an item such that the printed area said label is visible from above, under, or to the side of the item. The film strip may be removed prior to the removal of the at least one label from the label sheet.

In another embodiment, the die-cut individual label further includes a perforated tab. The perforated tab may assist in the removal of the individual labels from the label sheet. The perforated tab may thereafter be removed along the perforation, leaving just the shape of the desired label to be attached to an item. The film strip may also be removed to expose the adhesive for attachment of the label to the item.

The following description and the drawings disclose various illustrative aspects. Some improvements and novel aspects may be expressly identified, while others may be apparent from the description and drawings.

### BRIEF DESCRIPTION OF THE DRAWINGS

The present teachings may be better understood by reference to the following detailed description taken in connection with the following illustrations, wherein:

FIG. 1 is perspective, exploded view of an embodiment of a label sheet in accordance with aspects disclosed herein;

FIG. 2A is a cross-sectional view of an embodiment of a label sheet in accordance with aspects disclosed herein;

FIG. 2B is a cross-sectional view of an embodiment of a label sheet in accordance with aspects disclosed herein;

FIG. 3 is an embodiment of a label sheet with an individual label removed in accordance with aspects disclosed herein;

FIG. 4 is an embodiment of an individual label removed from a label sheet showing the removal of a perforated tab and film strip to reveal an adhesive in accordance with aspects disclosed herein;

FIG. 5 is an embodiment of a label sheet where an individual label and film are being removed in accordance with aspects disclosed herein;

FIG. 6 shows non-limiting examples of potential shapes and printable designs of the individual labels and its attachment to a badge in accordance with aspects disclosed herein; and

FIG. 7 shows examples of potential shapes and printable designs of the individual labels attached to a badge in accordance with aspects disclosed herein.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Further, unless context suggest otherwise, descriptions of shapes (e.g., circular, rectangular, triangular, etc.) refer to shapes meeting the definition of such shapes and general representation of such shapes. For instance, a triangular shape or generally triangular shape may include a shape that has three sides and three vertices or a shape that generally represents a triangle, such as a shape having three major sides that may or may not have straight edges, triangular like shapes with rounded vertices, etc.

While embodiments may refer to a particular example of the described label sheet as for use in badge applications, it is noted that disclosed embodiments may be applicable to various other items, products, and industries. Generally, described embodiments may be utilized for any application that requires labels, printable labels, etc. As an example, the label assemblies or label sheets may be utilized for attachment to office supplies or papers, such as a file folder or note book, as well as in decorative applications, such as a scrapbook or memory board.

Disclosed is a label sheet with removable at-home printable labels that provide adhesive on the front side of the printed label to be attached to the backside of an item, such as a badge. The label sheet may be used with any home or office printer, such as a laser printer, to allow easy use by an end user. The printed area of the label may be visible from above, under, or to the side of the badge to which it is attached. The label sheet may generally include a liner layer, a sheet of facestock or white substrate, a film, and at least one adhesive lane or portion. A user may print information on the label, such as information related to a person, an event, a service, or an award. The liner layer may have a siliconized area as to allow for easy removal of the facestock and adhesive from the liner layer for application to a product.

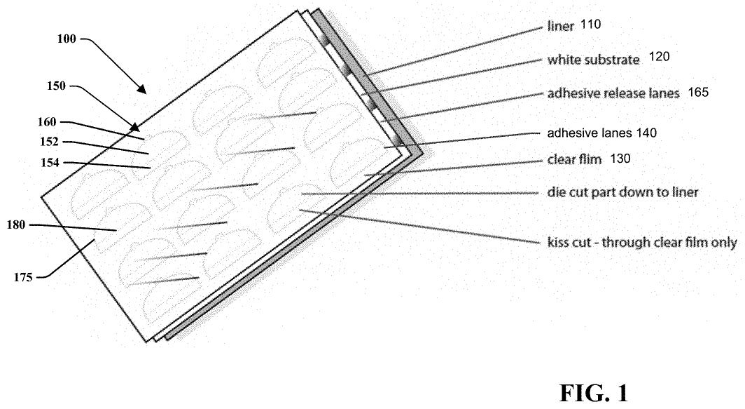

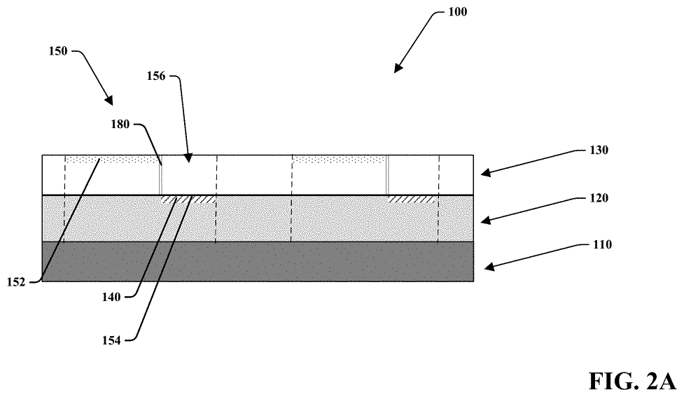

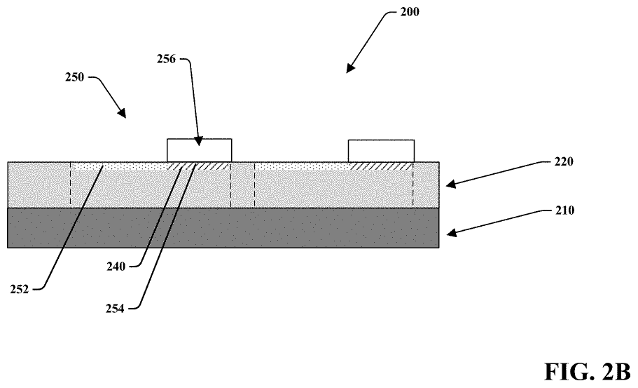

FIG. 1 depicts a perspective, exploded view of a label sheet 100 comprising a liner layer 110, a sheet of facestock or white substrate 120, a film 130, and at least one adhesive lane or portion 140 between the facestock or substrate 120 and the film 130. The liner layer 110, facestock or substrate 120, and film 130 may be independently square, rectangular, or some other shape and may be any material such as a substrate, polymer film, polyester label stock, paper, or a nonwoven material. The film may be translucent, opaque or it may be any other non-limiting color or material. In an embodiment, the label sheet 100 may be defined by a cutline such as a die-cut through the film 130, adhesive 140, and substrate 120 to form individual labels 150. Each label 150 includes a printable area 152 and an attachment portion 154. The cutline may be a die cut line that may include perforations thereon to assist with removal of the label 150 from the matrix portion of the facestock layer. In FIG. 1, the cutline is shown as line 175 that defines of the individual labels 150 as a non-limiting example. In FIGS. 2A and 2B a cross-sectional view of the cutline is shown as dotted lines as a non-limiting example. The individual labels 150 may be any shape and may be uniform through an entire label sheet 100, or the label sheet 100 may include individual labels 150 of various shapes.

The adhesive 140 may be provided in lanes across a length of the label sheet 100 and corresponding to the attachment portion 154 of the individual labels 150, or the adhesive 140 may be positioned on the attachment portion 154 of the individual labels 150 in separate and/or non-uniform segments. The printable area 152 of the individual labels 150 and the adhesive 140 are positioned on the same side of the label 150. The individual labels 150 may be adhesive free on the opposite side of the label 150 that is in contact with the liner layer 110. When the individual labels 150 are removed from the label sheet 100, the exposed portion of the liner layer 110 may also be adhesive free to allow for continued use of the label sheet 100 through a printer, such as an inkjet or laser printer (and in particular a non-commercial printer). When the adhesive 140 of the individual labels 150 is attached to an item, such as a badge, the printed area 152 of the individual label 150 may be visible from above, under, or to the side of the badge to which it is attached.

In an embodiment, the film 130 is a layer that generally corresponds to the entirety of the label sheet 100 as shown in FIGS. 1 and 2A, wherein the film 130, at least corresponding to the printable area 152 of the individual labels 150, is coated for printability. A cutline may extend through the film 130, so as to define a removable film strip 156 generally corresponding to the adhesive along an attachment portion 154 on the individual label 150. The remaining film 130 may be attached to the facestock 120 by a dry release adhesive. In FIG. 1, the cutline is shown as line 180 and as a non-limiting example, may represent a kiss cut. In FIG. 2A, the cutline for forming the removable film strip is shown as a double-black line 180 in a non-limiting example. The film strip 156 may be removed to expose the adhesive 140 and allow application of the label 150 to an item by applying pressure. The film 130 may be siliconized along the portion that contacts the adhesive 140 to allow for easy removal of the film strip 156. In another embodiment, as illustrated in FIG. 2B, the film strips 256 are provided in lanes or separate positions corresponding to the lanes or separate positions of the adhesive 240. The film strips 256 may not cover the facestock or white substrate layer 220 and information may be printed on the facestock or white substrate 220 directly. Generally, the individual label 150, 250 and the film strip 156, 256 may be removed from the label sheet 100, 200 as a unit. The film strip 156, 256 may also be removed prior to the removal of the individual label 150, 250 from the label sheet 100, 200.

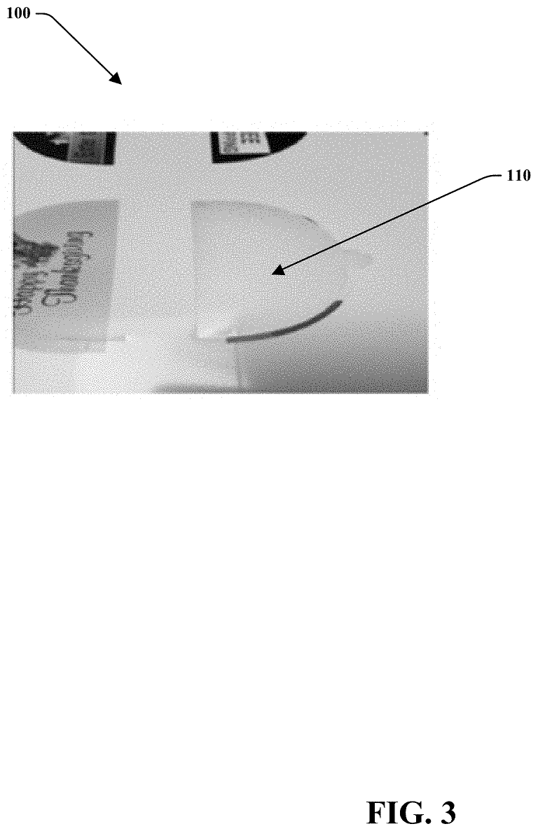

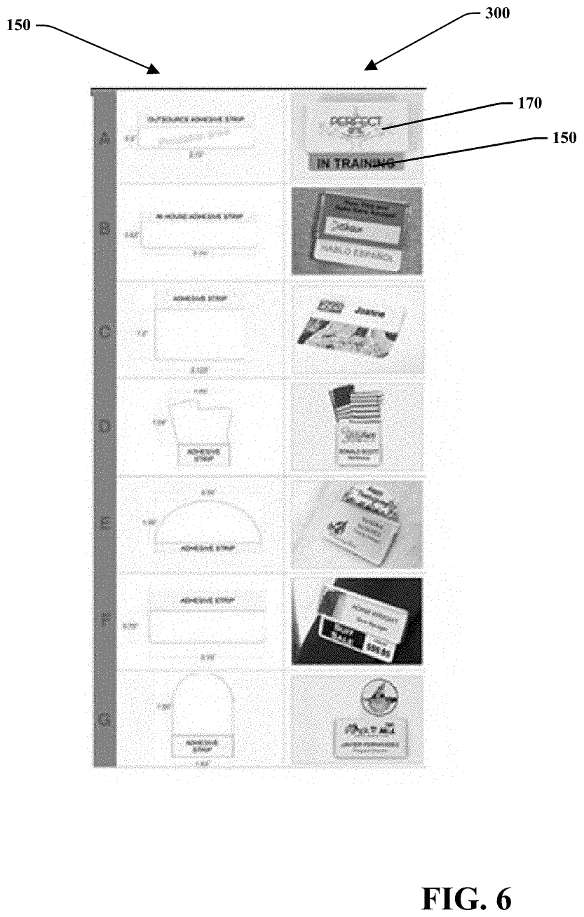

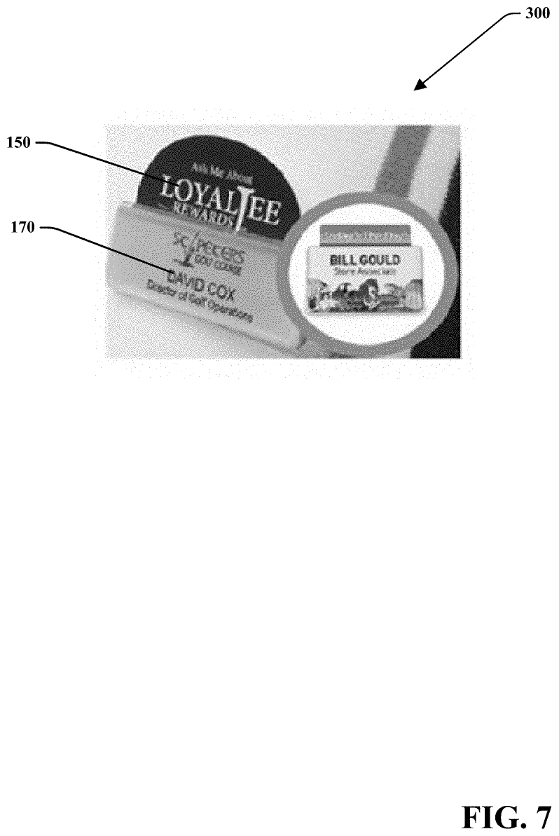

In an embodiment, the individual label 150 further includes a perforated tab 160. The perforated tab 160 may assist in the removal of the individual labels 150 from the label sheet 100. The perforated tab 160 may thereafter be removed along the perforation, leaving the shape of the desired label 150 to be attached to an item, such as a badge. Alternatively or additionally, the label sheet may comprise adhesive release lanes 165 between the liner layer 110 and the facestock 120, which may assist in the removal of the individual labels 150 from the liner layer 110. The individual labels may be attached to the liner layer 110 by a dry release adhesive. The film strip 156 may also be removed to expose the adhesive 140 for attachment of the label 150 to the item 170. For example, the adhesive 140 located on the front of a printed label 150 may be applied to the back of a badge 170 so that the printed area 152 of the label 150 may be visible from the front of the badge 170. FIGS. 3-5 show additional views of various embodiments of the label sheet 100 and individual labels 150 as the various components, such as the labels 150, perforated tab 160, and film strip 156 are removed. FIGS. 6 and 7 show various, non-limiting examples of printable designs, label 150 shapes, and attachment of the labels 150 to badges 170 to form a label assembly 300.

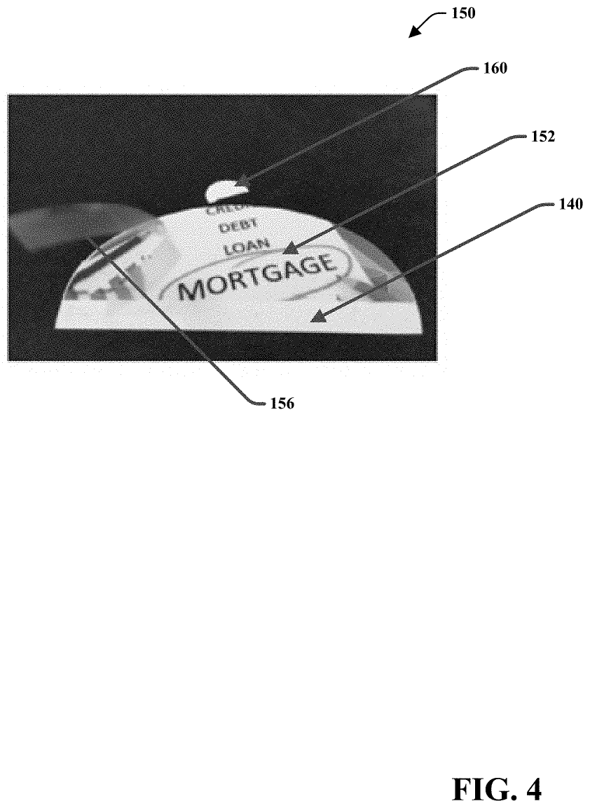

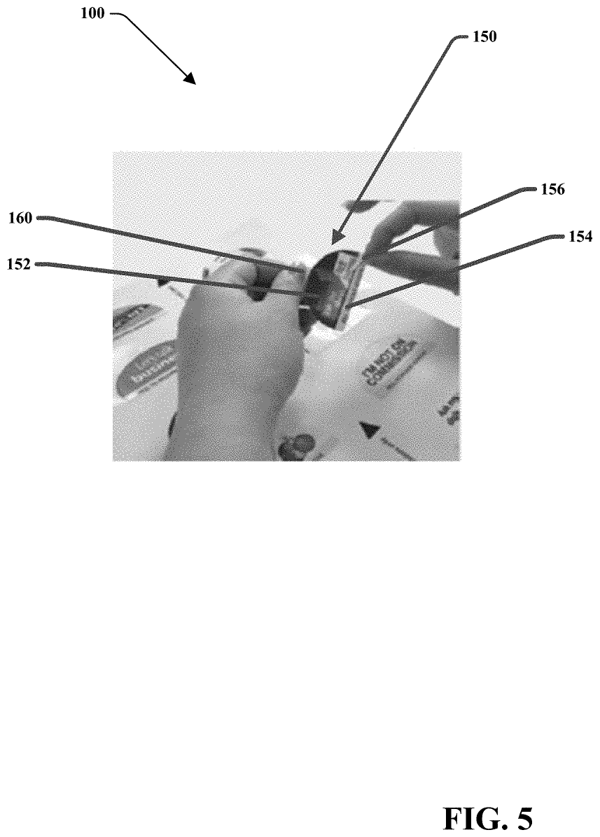

A method of using the label sheet 100 includes inserting the label sheet 100 into a printer (such as an inkjet or laser printer) where indicia such as information, a graphic, and/or a design is printed onto the label sheet 100, generally corresponding to a printable area 152 of the individual labels 150, see FIG. 5. The printed information, graphic, and design may be created in a corresponding software application, such as the NPG software. The individual labels 150 may thereafter be removed from the label sheet 100, see FIG. 3 showing the label sheet 100 after removal of a label 150 and FIG. 4 showing an individual label 150 after removal from the label sheet 110. The removal of the label 150 from the label sheet 100 may be enabled by the inclusion of a perforated tab 160 on the label 150 and/or adhesive release lanes 165 between the facestock 120 and liner layer 110. After removal of the label 150 from the label sheet 100, the perforated tab 160 may be removed from the remaining label 150 along the perforation, as shown in FIG. 4. In an embodiment, there may be no adhesive on the back of the individual label 150. Additionally or alternatively, there is also no adhesive on the exposed portion of the liner layer 110 from which the individual label 150 was removed. The liner layer 110 and the facestock 120 may be attached with a dry release adhesive. In an embodiment, the individual labels 150 are attached to the liner layer 110 by a dry release adhesive. As a result, the label sheet 100 may be inserted into the printer multiple times to utilize any remaining attached labels 150 even though some of the labels 150 have already been removed. This is particularly useful for users of an inkjet printer or even laser printer. Inkjet printers and to some extent laser printers have a tortious path that the item on which material is to be printed must pass. Getting labels or such devices through this tortious path can be difficult. The individual labels will often become disengaged from the liner layer. The embodiments disclosed herein overcome these shortcomings and allow a label sheet 100 to pass through the tortious path of the printer without having an individual label 150 becoming inadvertently disengaged. Moreover, the problem of label sheets going through the tortious path of the printer is especially problematic when individual labels have been removed before printing. Again, the embodiments disclosed herein overcome this shortcoming and the label sheet 100 with individual labels 150 removed is still able to go through the tortious path of the printer without having the remaining individual labels 150 becoming disengaged from the label sheet 100. The film strip 156 may be removed from the individual label 150 to expose the adhesive 140, as shown in FIG. 4. The individual label 150 may be applied to the backside of an item, such as a badge 170, as shown in FIGS. 6-7. The removable film strip 156 may be removed prior to the removal of the individual label 150 from the label sheet 100 or after the individual label 150 has been removed from the label sheet 100. When the adhesive 140 is attached to the backside of a badge 170, the printed area 152 of the individual label 150 may be visible from above, under, or to the side of the badge 170 to which it is attached.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof

What is claimed is:

1. A label sheet assembly configured to be processed through a printer device comprising:
a liner layer;
a facestock layer attached to the liner layer;
a film layer attached to the facestock layer opposite from the liner layer, and at least one adhesive area positioned between the facestock layer and the film layer;
a plurality of labels defined within the facestock layer wherein each label includes a front side and an opposite back side, the back side abuts the liner layer and the font side of each label includes a printable area and an attachment portion wherein the adhesive area is aligned along the attachment portion.

2. The label sheet assembly of claim 1, wherein the film layer includes a removable film strip shaped to correspond to the attachment portion of each label for protecting the adhesive area prior to its removal.

3. The label sheet assembly of claim 1, wherein each of the plurality of labels include a uniform shape.

4. The label sheet assembly of claim 1, wherein each of the plurality of labels include individual labels of various shapes.

5. The label sheet assembly of claim 1, wherein the adhesive area is a plurality of adhesive lanes wherein each adhesive lane extends along a length of the label sheet assembly and are positioned between the facestock layer and the film layer and align along the attachment portions of the plurality of labels.

6. The label sheet assembly of claim 1, wherein adhesive portions along the adhesive lanes are positioned on the attachment portion of the individual labels, wherein the adhesive portions are separate and/or non-uniform segments along a length of the label sheet assembly.

7. The label sheet assembly of claim 1, wherein the back side of the plurality of labels are adhesive free.

8. The label sheet assembly of claim 1, wherein the adhesive areas along the plurality of labels allow each label to be attached to an item such that the printed area of each of the plurality of labels are visible from above, under, or to the side of the item to which it is attached.

9. The label sheet assembly of claim 1, wherein film layer has a shape that generally corresponds to the shape of entirety of the facestock layer and includes a cut line that defines a film strip that is shaped to generally correspond to the adhesive portion along the attachment portion of each of the plurality of labels.

10. The label sheet assembly of claim 9, wherein the plurality of film strips does not cover the printable area of each of the plurality of labels.

11. The label sheet assembly of claim 1, wherein at least one of the plurality of labels includes a perforated tab to assist in the removal of the label from the label sheet.

12. The label sheet assembly of claim 1, wherein the liner layer, the facestock layer, and the film layer are square, or rectangular in shape and are made from a material such as a substrate, polymer film, polyester label stock, paper, or a nonwoven material.

13. The label sheet assembly of claim 1, wherein the plurality of labels are formed in the facestock layer by a die cut through at least one of the film layer, adhesive lane, and facestock layer.

14. A label sheet assembly configured to be processed through a printer device comprising:
a liner layer;
a facestock layer attached to the liner layer;
a film layer attached to the facestock layer opposite from the liner layer, and at least one adhesive area positioned between the facestock layer and the film layer; and
a plurality of labels defined within the facestock layer wherein each label includes a front side and an opposite back side, the back side abuts the liner layer and the font side of each label includes a printable area and an attachment portion wherein the adhesive area is aligned with the attachment portion;
wherein the film layer includes a film strip shaped to correspond to the attachment portion of each label for protecting the adhesive portion prior to use; and
wherein the adhesive areas along the plurality of labels allow each label to be attached to an item such that the printable areas of each of the plurality of labels are visible from above, under, or to the side of the item to which it is attached

15. A method of making a label for a badge from a sheet assembly comprising:
providing a label sheet assembly having a liner layer, facestock layer, and film layer wherein a plurality of cut lines define a plurality of labels within the facestock layer;
inserting the label sheet assembly into a printer;
printing indicia along a printable area on a first side of at least one of the plurality of labels, said printable area is positioned adjacent to an adhesive area on said first side of at least one of a plurality of labels defined within the label sheet assembly; and
removing the at least one label having indicia thereon.

16. The method of claim 15 wherein no adhesive remains on the portion of the liner layer from which the individual label was removed.

17. The method of claim 16 further comprising inserting the label sheet assembly into a printer to print indicia along the printable area of at least one of the remaining plurality of labels.

18. The method of claim 15 further comprising removing a film strip from one of the plurality of labels to expose the adhesive portion and applying said label to the backside of an item such that the printed area of each of said label is visible from above, under, or to the side of the item.

19. The method of claim 18 wherein the film strip is removed prior to the removal of the at least one label from the label sheet.
